(19) United States
(12) Patent Application Publication
(10) Pub. No.: US 2025/0328945 A1
(43) Pub. Date: Oct. 23, 2025

(54) MACHINE LEARNING MODELS FOR SESSION-BASED RECOMMENDATIONS

(71) Applicant: NVIDIA Corporation, Santa Clara, CA (US)

(72) Inventor: Jean-Francois PUGET, Saint Raphael (FR)

(21) Appl. No.: 18/643,675

(22) Filed: Apr. 23, 2024

(51) Int. Cl. G06Q 30/0601; H04L 67/50

(52) U.S. Cl. CPC G06Q 30/0631; H04L 67/535

(57) ABSTRACT

In various examples, session-based recommender model systems and applications are disclosed. Systems and methods are disclosed that use a cosine similarity loss during the training of a machine learning model to train the model to generate an item recommendation based on predicting a next item from a sequence of prior items selected within a session. A recommendation model is trained based on training data that represent an ordered sequence of user interactions with the set of items. A set of item embeddings is generated for the set of items. The recommendation model is trained to predict a session embedding that represents a user behavior pattern from a sequence of item embeddings. A cosine similarity loss computed from the session embedding and the item embeddings is used to train the recommendation model. The cosine similarity loss may include both positive and negative cosine similarity components.

### BACKGROUND

Session-based Recommendation (SBR) systems are often used to analyze a sequence of selections made by a user during an anonymous user session, and predict what that user is likely going to want to see next based on the sequence. As such, an SBR system can provide personalized recommendations based on a user's current session activities. Unlike traditional recommendation systems that are directed to discerning a user's long-term preferences, SBR systems focus on short-term preferences as indicated by interactions within a specific session (e.g., user clicks, views, selections, and/or purchases). SBR systems are therefore particularly useful in cases where user preferences change rapidly, or where they have context-specific needs that are unrelated to prior interactions.

### SUMMARY

Embodiments of the present disclosure relate to session-based recommender modeling. Systems and methods are disclosed that use a cosine similarity loss during the training of a machine learning model to train the model to generate an item recommendation based on predicting a next item from a sequence of prior items selected within a session.

In contrast to traditional SBR technologies, some of the embodiments described herein provide for an SBR recommendation model that is trained to generate next item recommendations within the context of a session using an embeddings-based cosine similarity loss function. For example, in some embodiments, a recommendation model is trained based on training data that includes session datasets that each represent an ordered sequence of user interactions with the set of items. A set of item embeddings is generated for the set of items, where an individual embedding of the item embeddings represents a respective individual item of the set of items. The set of items may correspond, for example, to a catalog of items that is available for a user to select from. The recommendation model is trained to generate a recommendation based on predicting a session embedding that represents a user behavior pattern with respect to user interactions with the set of items during a session captured by a session dataset. More specifically, the session embedding may be used to predict a next item in the order sequence of user interactions based on a previous sequence of user interactions from the ordered sequence of the session dataset. The training loss used to adjust the recommendation model is based on a cosine similarity loss. The cosine similarity loss may include both a positive cosine similarity component and a negative cosine similarity component. During training, the recommendation model is adjusted to drive the positive cosine similarity component to a maximum while driving the negative cosine similarity component to a minimum.

In some embodiments, the trained recommendation model may be used to recommend an item to a user based on the user's behavior pattern of interactions with other items of the set of items. For example, the recommendation model may produce a session embedding based on the item embeddings for items that the user has interacted with during a session, and perform a nearest neighbor search to identify at least one item embedding associated with an item from the set of items. The item having the item embodiment most similar to the session embedding may be used as an item recommendation that may then be presented on a user interface display that the user is using to interact with the set of items.

### BRIEF DESCRIPTION OF THE DRAWINGS

The present systems and methods for cosine similarity loss-based training for session-based recommender model systems and applications are described in detail below with reference to the attached drawing figures, wherein:

FIG. 1 is a data flow diagram illustrating a recommendation model training system, in accordance with some embodiments of the present disclosure;

FIG. 2 is a data flow diagram illustrating training of one or more convolution layers of a recommendation model;

FIG. 3 is another data flow diagram illustrating training of one or more convolution layers of a recommendation model;

FIG. 4 is a data flow diagram illustrating a recommendation system using a recommendation model trained in accordance with some embodiments of the present disclosure;

FIG. 5 is a flow diagram illustrating a method for recommendation model training, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to cosine similarity loss-based training for session-based recommender model systems and applications. As discussed herein, systems and methods are provided that use a cosine similarity loss during the training of a machine learning model to train the model to generate an item recommendation based on predicting a next item from a sequence of prior items selected within a session.

Session-based Recommendation (SBR) systems are used to analyze a sequence of selections made by a user during an anonymous user session, and predict what that user is likely going to want to see next based on the sequence. SBR systems focus on short-term preferences as indicated by user interactions with a set of items over a session (e.g., user clicks, views, selections, and/or purchases) and may be particularly useful in cases where user preferences change rapidly, or where they have context-specific needs that are unrelated to prior interactions.

Prior SBR technologies have relied on a variety of underlying methods. For example, some SBR technologies have used collaborative filtering based on matrix factorization. In such SBR systems, a latent vector, or embedding, is created for each session. Similarly, a latent vector, or embedding, is created for each product. These embeddings are used to define a matrix, S, of session embeddings and a matrix, P, of product embeddings. Embeddings may be calculated based on minimizing a root-mean-square error (RMSE) between the product S times P transposed (also known as a Frobenius norm). Once embeddings are computed, then for each session S, the next product is the product with the embedding most similar to the session embeddings product, where the similarity is computed by the dot product of the two embeddings. More recently, SBR has been addressed as a binary classification problem where a machine learning model takes as input all the previously visited products of a session along with a set of product candidates (e.g., products). The model predicts which of the candidates is the most likely to be visited. These machine learning models may be implemented as a deep learning model, a gradient boosted tree model, or other model that uses a cross-entropy loss or cross-entropy loss variant. Once the model is trained, it can be used to predict the next product for each session from previously visited products of the session and a set of product candidates. Other machine learning-based SBR techniques may use an encoder-decoder architecture where the encoder is implemented as a Recurrent Neural Network (RNN), Transformers, or Graph Neural Network (GNN), and the decoder predicts the next item based on calculating a dot product of session and item embeddings as an interaction probability. Training losses to train the models may be computed, for example, using a contrastive loss computation (e.g., as is often used within the context of vision tasks) that contrasts samples against each other to determine attributes that distinguish data classes from each other and those that the data classes share. However, because of limitations in the availability of training data for many languages, such techniques are often less accurate at generating relevant recommendations for sessions primarily conducted in lesser used languages (e.g., languages less frequently used during online sessions such as French, Italian, and Spanish) than more frequently used languages (e.g., Japanese, German, and English).

In contrast to these traditional SBR technologies, some of the embodiments described herein provide for an SBR recommendation model that is trained to generate next item recommendations within the context of a session using an embeddings-based cosine similarity loss function. For example, in some embodiments, a recommendation model is trained based on training data that includes session datasets that each represent an ordered sequence of user interactions with the set of items. A set of item embeddings is generated for the set of items, where an individual embedding of the item embeddings represents a respective individual item of the set of items. The set of items may correspond, for example, to a catalog of items that is available for a user to select from. For example, the catalog of items may comprise a catalog of products available for purchase, a catalog of streaming content available for streaming, media in a library available for loan to a library patron, a catalog of applications available for download, a catalog of instruction manuals and/or help files available for viewing, a catalog of classes available for registration to students, or any other set of discrete items with which a user can interact (e.g., by viewing, browsing, selecting, purchasing, accessing, downloading, and/or streaming). In some embodiments, item embeddings may comprise randomly generated latent vectors, with each individual item of the set of items associated with a respective embedding. In some embodiments, an item embedding may be generated for an item of the set of items based on processing an input individually characterizing the item using a machine learning model and extracting the embedding from the machine learning model. For example, an embedding may comprise a discrete internal latent vector representation, generated by the machine learning model, of an input to the machine learning model. In such an embodiment, an item embedding for an item may be computed by applying an input uniquely characterizing the item to a machine learning model (e.g., a natural language text recognition and/or classification model) and extracting the embedding from the machine learning model. The input may comprise an alphanumeric text describing the item, such as a catalog description or other text, which is processed by one or more large language models. The embeddings may be extracted, for example, from the last neural network layer of the machine learning model before the classification head and/or output layer. In some embodiments where the set of items may include a product catalog, embeddings may be computed from a concatenation of texts that characterize information such as, but not limited to, an item's locale, title, brand, color, price, size, model, and/or material. In order to increase diversity, texts may be truncated (e.g., taking only the first 80 tokens for title) for some implementations. For some embodiments, numerical information, such as price, may be converted to a textual representation. Moreover, price information for a product presented in different currencies may be normalized across countries, for example, to address when the same product can be present in more than one country. In some embodiments, the large language model(s) may include at least one multilingual large language model. The large language model(s) may comprise a pre-trained general-purpose language model, or a model trained at least in part based on the set of items. The set of item embeddings may be stored in a memory and/or data store that correlates individual item embeddings with their associated item.

Each item of the set of items thus represents a potential candidate item that a recommendation model is trained to recommend based on a user's pattern of interactions with other items of the set of items that occur during a session. As mentioned above, the training data may include session datasets that each represent an ordered sequence of user interactions with the set of items. The recommendation model is trained to generate a recommendation based on predicting a session embedding that represents a user behavior pattern with respect to user interactions with the set of items during a session captured by a session dataset. More specifically, the session embedding may be used to predict a next item in the order sequence of user interactions based on a previous sequence of user interactions from the ordered sequence of the session dataset. In some embodiments, a session embedding is generated from item embeddings corresponding to a portion (e.g., subsequence) of the ordered sequence of user interactions represented in a session dataset. As an example, a session dataset may comprise an ordered sequence of M user interactions with items of the set of items. For purposes of training (updating) the recommendation model, a portion of user interactions with S items from the ordered sequence may be used to compute a session embedding. A portion of the S item embeddings associated with the S items—and in a chronological order of the user interactions—may be applied to the recommendation model, and a convolution computation applied by the recommendation model to generate a latent vector corresponding to a session embedding represents a user behavior pattern with respect to the sequence of S items. The recommendation model may be implemented at least in part using a Convolutional Neural Network (CNN) that includes at least one convolutional layer to convolve the portion of the S item embeddings to produce the session embedding. The convolution computation generates a session embedding having the same dimensions as the individual item embedding.

The resulting session embedding may be compared to the item embedding for the next item in the session dataset ordered sequence occurring after the portion of S items. That is, the item embedding for the next item in the ordered sequence may be used as a ground truth data sample for generating a training loss used to adjust the recommendation model. For the next training iteration, the portion of user interactions may be chronologically advanced such that the item embedding for the next item of the prior iteration becomes the most recent item embedding of the portion S, and the embedding associated with the oldest user interaction is dropped from the portion. The item embeddings associated with the new portion are applied to the recommendation model in the same way to generate a new session embedding. The resulting updated session embedding may be compared to the item embedding for a next item in the session dataset ordered sequence occurring after the new portion of S items. Such iterations may continue through the ordered sequence of a session dataset, and may be repeated for each session dataset available from the training data. By processing through session datasets available from the training data, the recommendation model may be iteratively adjusted using the training loss, until the session embedding produced by the recommendation model converges on the ability to accurately predict next items in the ordered sequence following the sequence used to compute the session embedding (e.g., within a specified accuracy threshold).

As discussed herein, in some embodiments, the training loss used to adjust the recommendation model is based on a cosine similarity loss. The cosine similarity loss represents a similarity between the session embedding and the item embedding associated with the corresponding next item in the ordered sequence. The cosine similarity loss may include both a positive cosine similarity component and a negative cosine similarity component. During training, the recommendation model is adjusted to drive the positive cosine similarity component to a maximum (e.g., to maximize the positive cosine similarity component and thus maximize similarity) while driving the negative cosine similarity component to a minimum (e.g., to minimize the negative cosine similarity component and thus minimize similarity). For example, given the predicted session embedding S, and the item embedding P, for the next item in the ordered sequence, the positive cosine similarity component may be computed as 1 minus the cosine similarity, which may be expressed as:

$${loss}_{+} ( S , P ) = 1 - \frac{S \cdot P}{‖ S ‖ \cdot ‖ P ‖} .$$

The negative cosine similarity component may be computed based on evaluating the similarity between the predicted session embedding S and item embeddings for a set of randomly selected items of the set of items. Given the predicted session embedding S, and an item embedding R for a negative item embedding from the set of randomly selected item embeddings, the negative cosine similarity component may be computed as a cosine similarity that may, for example, be expressed as:

$${loss}_{-} ( S , R , margin ) = max ( 0 , \frac{S \cdot P}{‖ S ‖ \cdot ‖ P ‖} - margin ) .$$

That is, the loss has a value that represents a cosine similarity, if the similarity is above a margin value, and zero otherwise. The margin value may be adjusted based on the use case of the recommender model, for example, to address limits in training data available for item interactions that involve an infrequently used language. A margin of 0.65 or higher may be appropriate to facilitate training data comprising interactions in less frequently used languages such as French, Italian, and/or Spanish, for example and without limitation. Margins less than 0.65 may be appropriate to facilitate training data comprising interactions in more frequently used languages such as German, Japanese, and/or English. The number of random items R represented by the set of randomly selected item embeddings may similarly be selected based on use case and/or a target degree of accuracy in the next item predictions. For example, in various embodiments, the number of random item samples used to define the set of randomly selected item embeddings may include a plurality of embeddings (e.g., a range from tens of samples to many thousands of samples). Moreover, in some embodiments, the set of randomly selected item embeddings may be refreshed to include a different set of randomly selected samples for each training iteration, for each item sequence of a session, or based on another criteria. The negative cosine similarity component may include a cosine similarity loss, loss₋(S, R, margin), calculated for each of the randomly selected items. During training, the recommendation model is adjusted to maximize the value of the positive cosine similarity component, loss₊(S, R), while optimally minimizing the set of negative cosine similarity losses loss₋(S, R, margin). That is, a first convolution embedding may be computed for the portion of user interactions to predict the last embedding the portion from the prior embedding in the portion. Based on the similarity of that first convolution embedding and the last embedding, a first positive cosine similarity component can be computed, and also a first negative cosine similarity component for the first convolution embedding can be computed, as described above. The convolution window is then advanced by one item embedding to compute the session embedding and compared to the embedding of a next item in the ordered sequence after the portion. Based on the similarity of the session embedding and the next item embedding, a second positive cosine similarity component can be computed, and also a second negative cosine similarity component for the session component can be computed, as described above. In such an embodiment, the recommender model may be adjusted at each training iteration to maximize the values of the first and second positive cosine similarity components (e.g., both of the loss₊(S, R) loss values), while optimally minimizing the set of negative cosine similarity losses loss₋(S, R, margin) included in the first and second negative cosine similarity components.

In some embodiments, the trained recommendation model may be used to recommend an item to a user based on the user's behavior pattern of interactions with other items of the set of items. For example, the recommendation model may produce a session embedding based on the item embeddings for items that the user has interacted with during a session, and perform a nearest neighbor search to identify at least one item embedding associated with an item from the set of items. The item having the item embodiment most similar to the session embedding may be used as an item recommendation that may then be presented on a user interface display that the user is using to interact with the set of items.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) and/or one or more vision language models (VLMs), systems for performing light transport simulation, systems for performing collaborative content creation for 3D assets, systems implemented at least partially using cloud computing resources, and/or other types of systems.

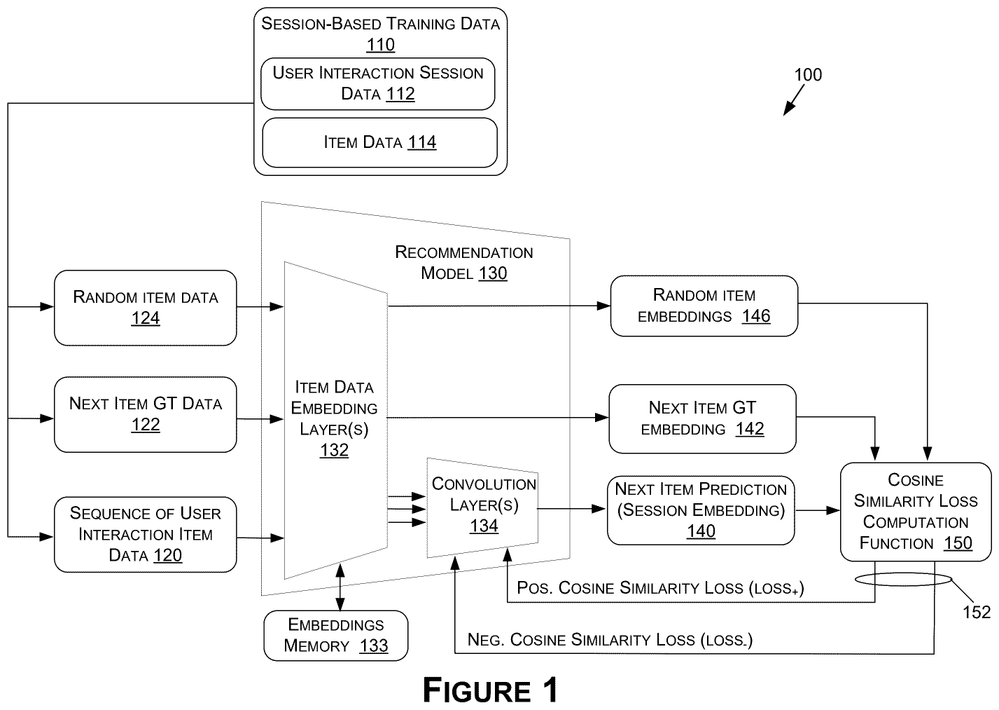

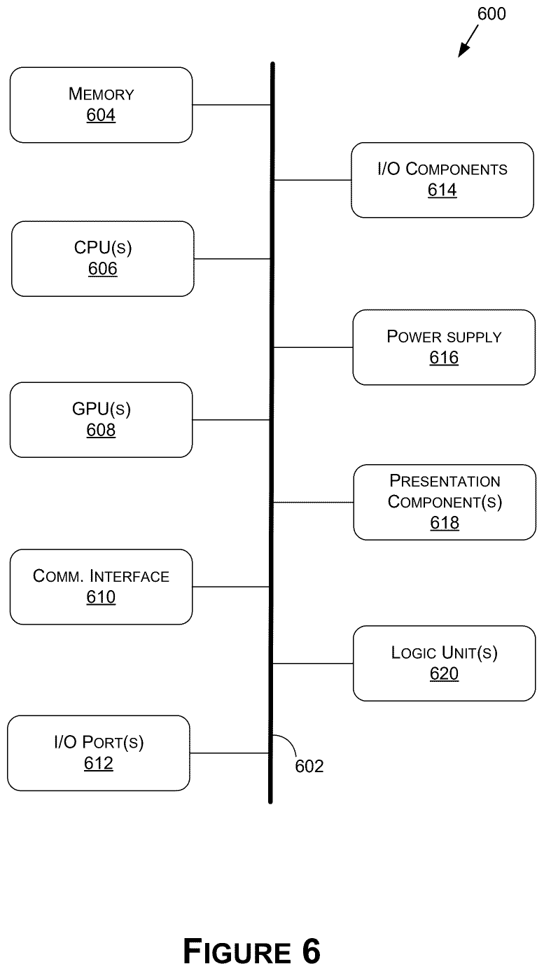

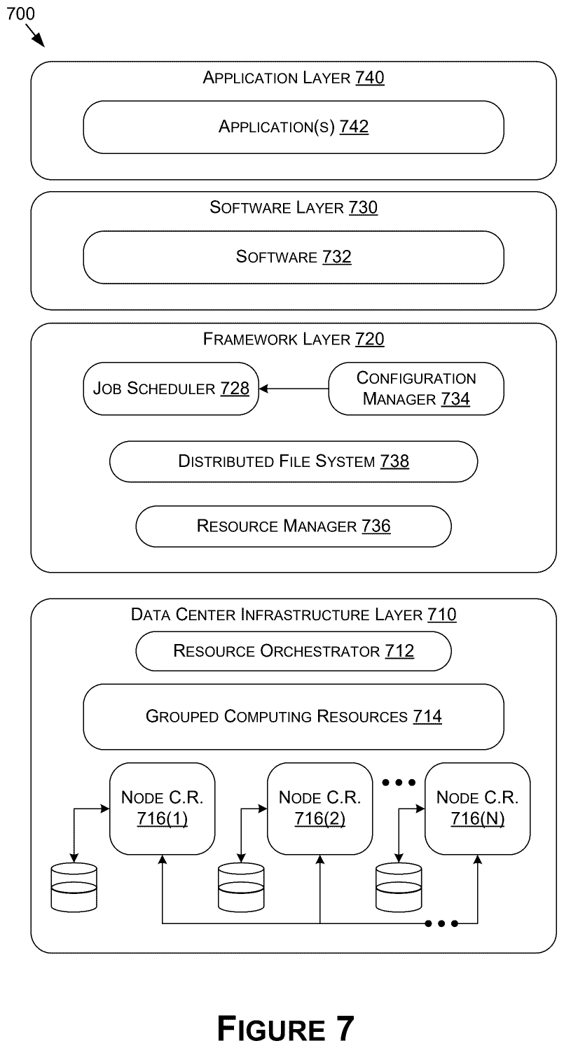

With reference to FIG. 1, FIG. 1 is an example data flow diagram for a recommendation model training system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example computing device 600 of FIG. 6 and/or example data center 700 of FIG. 7.

As shown in FIG. 1, recommendation model training system 100 may comprise a recommendation model 130 that is trained using session-based training data 110 to generate next item recommendations. Training data 110 includes user interaction session data 112 that comprises session datasets that each represent an ordered sequence of user interactions with a set of items such as item data 114. The item data 114 may correspond, for example, to a catalog of items that is available for a user to select from or otherwise interact with. For example, the item data 114 may comprise a catalog of products available for purchase, a catalog of streaming content available for streaming, media in a library available for loan to a library patron, a catalog of applications available for download, a catalog of instruction manuals and/or help files available for viewing, a catalog of classes available for registration to students, or any other set of discrete items with which a user can interact (e.g., by viewing, browsing, selecting, purchasing, accessing, downloading, and/or streaming). The session data sets represented by the user interaction session data 112 each correspond to a distinct session of user interactions with the item data 114, and further capture an ordered sequence in which those user interactions occurred. In some embodiments, the user interaction session data 112 may comprise ground truth (GT) user interaction data derived from observing user interactions with the item data 114 over the course of a session (e.g., a duration of time in which a user is maintaining an active state with a resource via a browsing Instance). That is, given an ordered sequence corresponding to a session of user interactions with the item data 114, knowledge from the sequence of a next item selected by the user after a preceding portion of interactions may be used as ground truth training data for training a machine learning model to predict the next item from the preceding portion.

In FIG. 1, in some embodiments, recommendation model 130 comprises an SBR recommendation model that is trained to generate next item recommendations within the context of a session, using an embeddings-based cosine similarity loss function.

In some embodiments, recommendation model 130 may include one or more item data embedding layers 132 and one or more convolution layers 134. As described herein, the one or more item data embedding layers 132 generate individual item embeddings associated with a respective item of the item data 114. In some embodiments, item embeddings produced by data embedding layer(s) 132 may comprise latent vectors generated and assigned to individual items based on arbitrary criteria. For example, the latent vectors may be previously generated on a random basis and stored in a database accessed by the recommendation model 130 to determine individual item embeddings for individual items of the item data 114.

In some embodiments, an item embedding may be generated by data embedding layer(s) 132 for an item based on processing an input individually characterizing the item using a machine learning model and extracting the embedding from the machine learning model. For example, an embedding may comprise a discrete internal latent vector representation, generated by the machine learning model, of an input to the machine learning model. In such an embodiment, an item embedding for an item may be computed by applying item data uniquely characterizing the item to data embedding layer(s) 132 (e.g., which may be implemented using a natural language text recognition model, large language model (LLM), and/or classification model) and extracting the embedding from the item data embedding layer(s) 132. The item data characterizing the item may comprise an alphanumeric text describing the item, such as a catalog description or other text, which is processed by one or more (e.g., large) language models. In some embodiments, the data embedding layer(s) 132 may include at least one multilingual large language model. The data embedding layer(s) 132 may comprise a pre-trained general-purpose language model, or a model trained at least in part based on the item data 114. The set of item embeddings may be stored in a memory and/or data store (shown in FIG. 1 as embeddings memory 133) that correlates individual item embeddings with their associated item for subsequent use by the recommendation model 130.

In FIG. 1, the item data used in training the recommendation model 130 may include a sequence of user interaction item data 120, next item ground truth (GT) data 122 and random items data 124. The user interaction item data 120 and next item GT data 122 may correspond to an ordered sequence of user interactions where the user interaction item data 120 represents items from a portion of user interactions that preceded user interaction with an item represented by next item GT data 122. The training goal of recommendation model training system 100 is to train the convolution layer(s) 134 of recommendation model 130 to predict the embedding of next item GT data 122 based on performing a convolution of embedding derived from the user interaction item data 120. The next item prediction is computed in the form of a session embedding obtained from the convolution layer(s) 134 and a cosine similarity between the session embedding, and the embedding for the next item GT data 122 is used for computing a positive cosine similarity component of the cosine similarity loss used for adjusting the convolution layer(s) 134. The item data embedding layer(s) 132 may also generate item embedding from random items data 124, which as described herein is used for computing a negative cosine similarity component of the cosine similarity loss. In some embodiments, the recommendation model 130 may comprise an integration of distinct machine learning model layers including the item data embedding layer(s) 132 and the convolution layer(s) 134. In some embodiments, the recommendation model 130 may be implemented by separate machine learning models where the item data embedding layer(s) 132 are implemented by a first machine learning model, and the convolution layer(s) 134 is implemented by a second machine learning model that receives as input embedding data produced by the first machine learning model. In some embodiments, the item data embedding layer(s) 132 may be implemented based on a deep neural network (DNN) architecture, recurrent neural network (RNN) architecture, autoencoder architecture, or other neural network architecture. The convolution layer(s) 134 may be implemented based on a deep neural network (DNN) architecture such as, but not limited to, a convolutional neural network (CNN), for example.

As discussed herein, item embedding representing the user interaction item data 120, next item GT data 122 and random items data 124 may be extracted from the item data embedding layer(s) 132, for example, from a last neural network layer before a classification head and/or output layer. In some embodiments, embeddings may be computed from item data that includes a concatenation of texts that characterize information such as, but not limited to, an item's locale, title, brand, color, price, size, model and/or material, and/or other characterizing information.

In the context of a recommendation system, each item of the item data 114 represents a potential candidate item that the recommendation model 130 may be trained to recommend based on a pattern of previous user interactions with other items of the item data 114 that have occurred during a session. The training data 110 may include user interaction session data 112 that comprises session data sets that each represent an ordered sequence of user interactions with the item data 114. As shown in FIG. 1, the item data embedding layer(s) 132 inputs the random items data 124 to generate random item embeddings 146, and inputs net item GT data 122 to generate next item GE embedding 142. From the sequence of user interaction item data 120, the item data embedding layer(s) 132 inputs the item data corresponding to the portion of user interactions, and from that item data generates a sequence of item embeddings that is input by the convolution layer(s) 134. A session embedding 140, which represents a next item prediction, is generated by the convolution layer(s) 134 from those item embeddings.

To generate a training loss 152 for training the convolution layer(s) 134, the session embedding 140 output from the recommendation model 130 may be compared to the next item GT embedding 142, which represents the next item in the ordered sequence occurring following user interaction data 120. The training loss 152 used to adjust the convolution layer(s) 134 of recommendation model 130 is based on a cosine similarity loss computed by a cosine similarity loss computation function 150. The cosine similarity loss represents a similarity between the session embedding 140 and the next item GT embedding 142 and may be further based on dissimilarity between the session embedding 140 and arbitrarily selected items as represented by the random item embeddings 146. As such, the training loss 152 may include both a positive cosine similarity component (which may be expressed as discussed above by loss₊) and a negative cosine similarity component (which may be expressed as discussed above by loss₋). During training, the recommendation model 130 (e.g., the convolution layer(s) 134) is adjusted to drive the positive cosine similarity component towards a maximum, thus teaching the convolution layer(s) 134 to iteratively produce a session embedding 140 increasingly similar to next item GT embedding 142. With respect to the negative cosine similarity component, for each of the random item embeddings 146, a corresponding negative cosine similarity (which may be expressed as discussed above by loss₋) is computed. During training, the recommendation model 130 (e.g., the convolution layer(s) 134) is adjusted to drive each of the negative cosine similarity loss components towards a minimum, thus teaching the convolution layer(s) 134 to iteratively produce a session embedding 140 increasingly dissimilar to embeddings for random items of the item data 114. In this way, the recommendation model 130 learns to more accurately discern an embedding to predict the next item from the embedding of items not corresponding to the predicted next item.

The number of random items to include in the set of random items data 124 may be determined based on use case considerations. For example, where the item data 114 includes a population of items that are relatively similar to each other, the number of random items used to compute the negative cosine similarity component may be increased to assist training the recommendation model 130 in distinguishing between those differentiating characteristics that do exist. Similarly, where the item data 114 includes a relatively limited number of distinct items to use in training, the number of random items used to compute the negative cosine similarity component may be increased to assist training the recommendation model 130 to learn dissimilarities between embeddings for predicted items versus arbitrary items from the item data 114. In some embodiments, the set of random items data 124 used to generate the random item embeddings 146 may be refreshed for each training iteration (e.g., a new set of random items data 124 may be selected from the item data 114 for each new instance of sequence of user interaction item data 120).

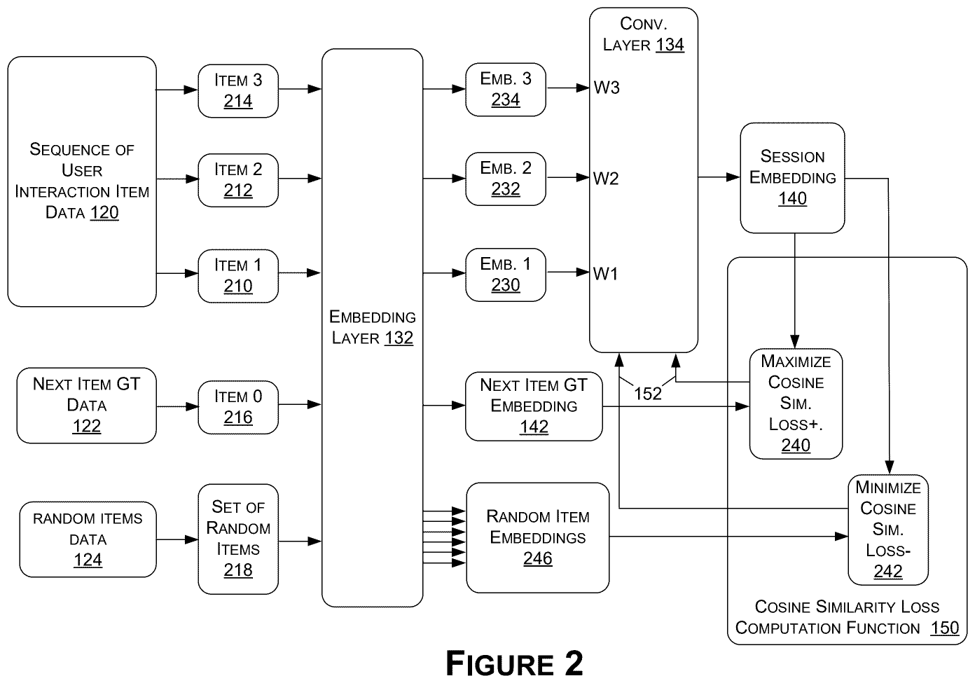

Referring now to FIG. 2, FIG. 2 is a data flow diagram illustrating an example of training of the convolution layer(s) 134 of a recommendation model (such as recommendation model 130) to generate a session embedding 140 corresponding to a next item prediction. In this example, the sequence of user interaction item data 120 includes item data for a first item (item 1, 210), a second item (item 2, 212) and a third item (item 3, 214). Item 1 (210) may represent the item that the user most recently interacted with. Item 2 (212) may represent the item that the user most recently interacted with prior to item 1 (210). Item 3 (214) may represent the item that the user most recently interacted with prior to item 2 (212). The item 1 (210), item 2 (212), and item 3 (214) thus represent a portion from a session dataset that represents an ordered sequence of user interactions with the item data 114 over the course of a session. The item 1 (210), item 2 (212), and item 3 (214) portion may be applied to the item embedding layer(s) 132 to produce a respective item embedding 1 (EMB. 1, 230), item embedding 2 (EMB. 2, 232), and item embedding 3 (EMB. 3, 234). The item embeddings 230, 232, and 234 may in turn be applied to the convolution layer(s) 134 to perform a convolution to generate session embedding 140. In some embodiments, the item embeddings 230, 232, and 234 may be weighted by the convolution layer(s) 134 with a greatest weight (W1) applied to the embedding associated with the most recent user interaction (e.g., item embedding 230) and decreasing weights (W2, W3) applied to the embeddings associated with increasingly older user interactions. Session embedding 140 represents the prediction from the recommendation model 130 of the item that the user would most likely interact with next, whereas next item GT data 122 represents item 0 (216)—the GT next item (per training data 110) that the user next interacted with after interacting with item 1 (210). In contrast, the set of random items 218 represents items from the item data 114 that have no particular intentional correlation to the sequence of items 210, 212, and 214 other than also being members of the item data 114. As such, the recommendation model training system 100, using cosine similarity loss computation function 150, attempts to train the convolution layer(s) 134 to increase the probability that the convolution layer(s) 134 will correctly infer from the item embeddings 230, 232, and 234 that item 0 (216) is what the user wants to interact with next. As discussed, the item data embedding layers 132 compute the next item GT embedding 142 corresponding to the next item, item 0 (216). The item embedding 142 for item 0 (216) may be used as a ground truth data sample for generating the training loss 152 used to adjust the recommendation model 130.

Cosine similarity loss computation function 150 computes a cosine similarity loss that includes a positive cosine similarity component and a negative cosine similarity component. The cosine similarity loss computation function 150 compares the session embedding 140 and the next item GT embedding 142 and computes a positive cosine similarity component that the recommendation model training system 100 attempts to maximize (shown at 240) by applying a positive loss component of the training loss 152 as feedback to adjust the convolution layer(s) 134. The cosine similarity loss computation function 150 compares the session embedding 140 and the plurality of embeddings from the random item embeddings 246, and computes a negative cosine similarity component that may include a corresponding plurality of negative cosine similarity losses that the recommendation model training system 100 attempts to minimize (shown at 242) by applying a negative loss component of the training loss 152 as feedback to adjust the convolution layer(s) 134. For the next training iteration, the user interactions for computing the session embedding may be chronologically advanced such that the item embedding for the next item (item 0) of the prior iteration becomes the most recent item (item 1) embedding of the portion, and the embedding associated with the oldest user interaction (item 3) is dropped from the portion. Such iterations may continue through the ordered sequence of a session dataset, and may be repeated for each session dataset available from the training data 110. By processing through session datasets available from the training data 110, the recommendation model 130 may be iteratively trained using the training loss 152, until the session embedding 140 produced by the recommendation model 130 converges on accurately predicting the embedding 142 for item 0 (216) within a specified accuracy threshold.

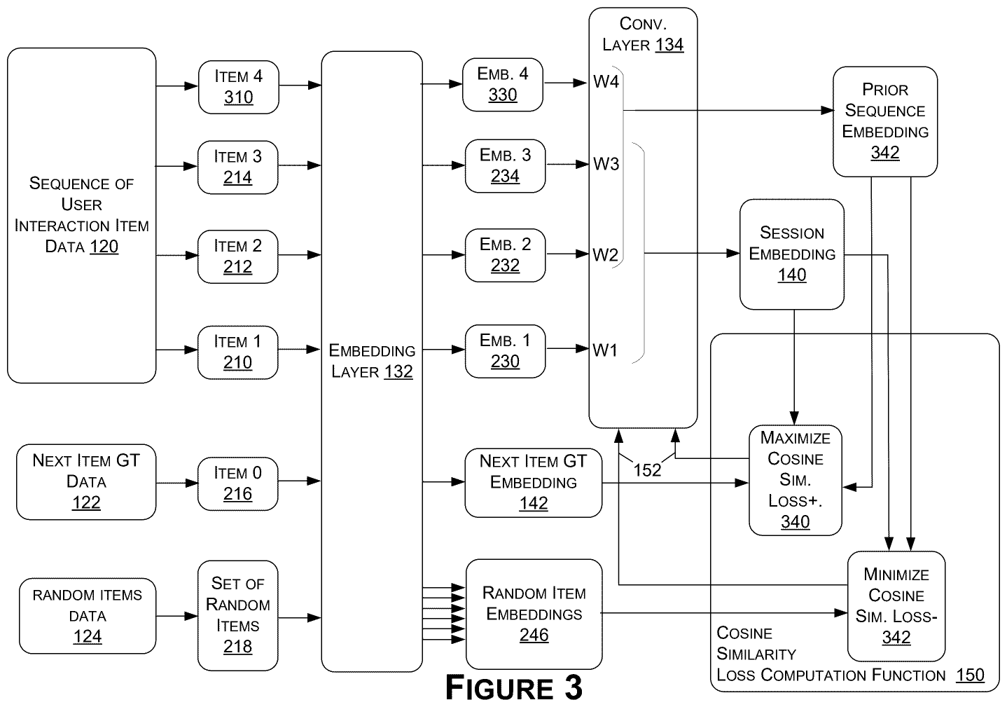

Referring now to FIG. 3, FIG. 3 is a data flow diagram illustrating another example of training of the convolution layer(s) 134 of a recommendation model (such as recommendation model 130) to generate a session embedding 140 corresponding to a next item prediction. In this example, the convolution layer(s) 134 computes a set of embeddings-a session embedding 140 computed as described with respect to FIG. 2 and a prior sequence embedding 342, and uses both the session embedding 140 and the prior sequence embedding 342 in computing the training loss 152 for adjusting the convolution layers 134. In this embodiment, the sequence of user interaction item data 120 includes item data for a first item (item 1, 210), a second item (item 2, 212), a third item (item 3, 214) and a fourth item (item 4, 310). Item 1 (210) may represent the item that the user most recently interacted with. Item 2 (212) may represent the item that the user most recently interacted with prior to item 1 (210). Item 3 (214) may represent the item that the user most recently interacted with prior to item 2 (212). Item 4 (310) may represent the item that the user most recently interacted with prior to item 3 (212). The item 1 (210), item 2 (212), item 3 (214), and item 4 (310) thus represent a portion from a session dataset that represents an ordered sequence of user interactions with the item data 114 over the course of a session. The item 1 (210), item 2 (212), item 3 (214), and item 4 (310) portion may be applied to the item embedding layer(s) 132 to produce a respective item embedding (230), item embedding 2 (232), item embedding 3 (234), and item embedding 4 (EMB. 4, 330).

As discussed with respect to FIG. 2, the item embedding 230, 232, and 234 may in turn be applied to the convolution layer(s) 134 to generate session embedding 140. While the item embeddings 230, 232, and 234 represent a most recent portion, the item embeddings 232, 234, and 330 represent an overlapping prior portion. Whereas item 0 (216) represents the next item with respect to item embeddings 230, 232, and 234, item 1 (210) represents the next item with respect to item embeddings 232, 234, and 330. The item embeddings 230, 232, 234, and 330 may be weighted by the convolution layer(s) 134 with a greatest weight (W1) applied to the embedding associated with the most recent user interaction (e.g., item embedding 230) and decreasing weights (W2, W3, and W4) applied to the embeddings associated with increasingly older user interactions.

Prior sequence embedding 342 represents a prediction of item embedding 1 (230) based on the convolution of the sequence of item embeddings 232, 234, and 330-a sequence shifted in time by one user interaction from the item embeddings 230, 232, and 234. Cosine similarity loss computation function 150 computes a cosine similarity loss that includes a positive cosine similarity component and a negative cosine similarity component. In some embodiments, the cosine similarity loss computation function 150 compares the session embedding 140 to the next item GT embedding 142 and computes a first positive cosine similarity component loss (e.g., a first loss₊), and compares the prior sequence embedding 342 to the first item embedding 230 and computes a second positive cosine similarity component (e.g., a second loss₊). During training, the recommendation model training system 100 attempts to maximize both the first and second positive cosine similarity component losses (shown at 340) by applying a positive loss component of the training loss 152 as feedback to adjust the convolution layer(s) 134.

The cosine similarity loss computation function 150 also compares the session embedding 140 to a first plurality of embeddings from the random item embeddings 246 and computes a first set of negative cosine similarity component losses (e.g., a first set of loss₋), and compares the prior sequence embedding 342 to a second plurality of embeddings from the random item embeddings 246 and computes a second set of negative cosine similarity component losses (e.g., a second set of loss₋). During training, the recommendation model training system 100 attempts to minimize both the first and second negative cosine similarity component losses (shown at 342) by applying a negative loss component of the training loss 152 as feedback to adjust the convolution layer(s) 134.

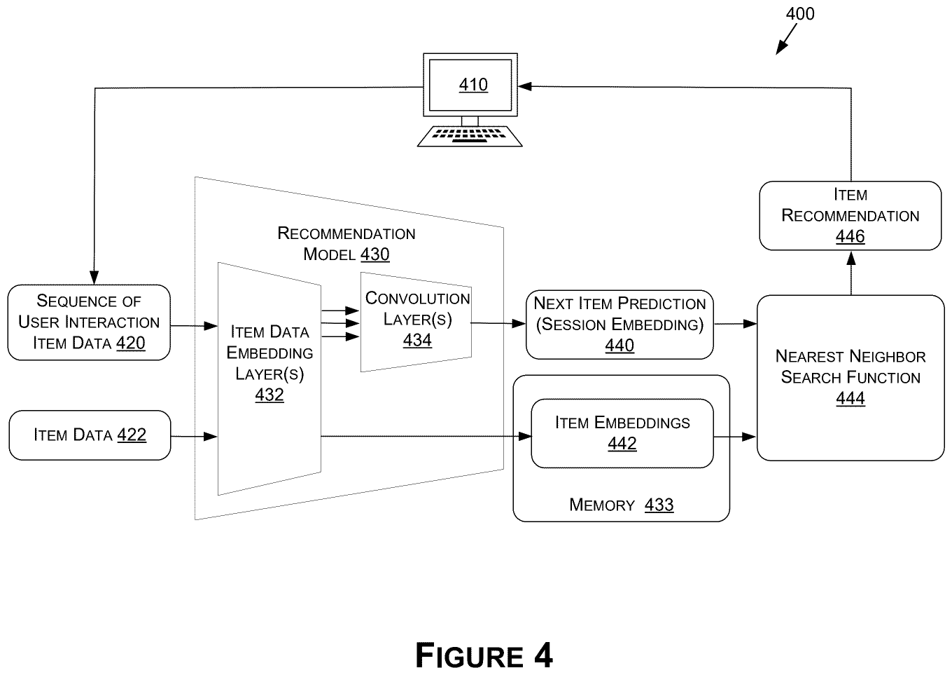

FIG. 4 is a data flow diagram illustrating a recommendation system 400 and a trained recommendation model 430 that may be used to recommend items from item data 422 to a user based on the user's behavior pattern of user interactions with other items of the item data 422 during a session. The trained recommendation model 430 may include one or more convolution layers 434 (such as the convolution layer(s) 134) that are trained to compute a session embedding 440 that represents a next item prediction. In some embodiments, the trained recommendation model 430 is implemented, for example, by a recommendation model 130 that has been trained using cosine similarity loss-based training as described with respect to FIGS. 1-3 and/or any of the embodiments discussed herein. As shown in FIG. 4, a sequence of user interaction item data 420 may be generated based on user interaction with the set of items 422 via a computer device 410, such as the computer device 600 described with respect to FIG. 6 and/or via an application executed at a cloud-based data center, such as data center 700 described with respect to FIG. 7. Based on the sequence of user interaction item data 420, one or more item data embedding layers 432 (such as the item embedding layer(s) 132) of the trained recommendation model 430 may compute item embeddings that are applied to the convolution layer(s) 434 to produce the session embedding 440 representing a next item prediction. In some embodiments, the recommendation system 400 further includes a nearest neighbor search function 444 that performs a nearest neighbor search to correlate the session embedding 440 with an item from the item data 422. More specifically, recommendation system 400 includes item embeddings 442 that includes individual item embeddings that respectively correspond to individual items from the item data 422. In some embodiments, the item embedding 442 may be computed by item data embeddings layer(s) 432 from item data representative of the item data 422. In some embodiments, the item embeddings 442 may be stored to a memory 433 of the recommendation system 400 that correlates individual item data embeddings to their respective associated individual items of the item data 422. The item embeddings 442 may be accessed by the nearest neighbor search function 444 to perform a nearest neighbor search based on a similarity between embeddings. That is, the nearest neighbor search function 444 may perform a similarity search based on a nearest neighbor algorithm to identify a recommended item embedding from the item embeddings that is the item embedding most similar (e.g., a nearest neighbor) to the session embedding 440. Based on the recommended item embedding, the recommendation system 400 may access the item embeddings 422 in memory 433 to correlate the recommended item embedding with an item from the item data 422 and output an item recommendation 446. The recommendation system 400 may output the item recommendation 446 back to the computer device 410 to display to the user of the computer device 410 as a suggestion for their next interaction with the item data 422.

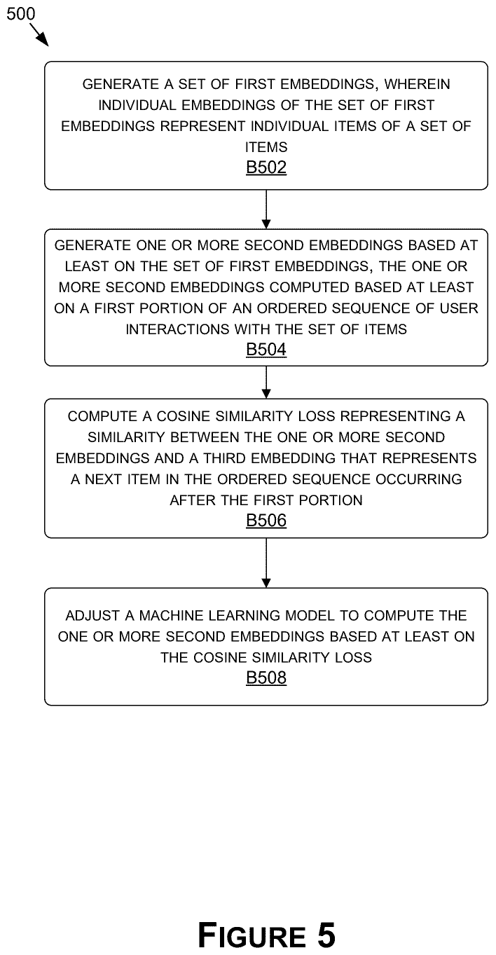

Now referring to FIG. 5, FIG. 5 is a flow diagram showing a method 500 for training a recommendation model for a session-based recommendation system, in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa.

Each block of method 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 500 is described, by way of example, with respect to recommendation model training system 100 of FIG. 1. However, these methods may additionally or alternatively be executed by any one system, or any combination of systems, including, but not limited to, those described herein.

As discussed herein in greater detail, the method may include updating one or more parameters of a machine learning model to generate a recommendation from a set of items based at least on a cosine similarity loss that represents a similarity between one or more embeddings representing a portion of an ordered sequence of user interactions with the set of items and an embedding that represents a next item in the ordered sequence occurring after the portion.

Method 500, at B502, includes generating a set of first embeddings, wherein individual embeddings of the set of first embeddings represent individual items of a set of items. As discussed above, the set of embeddings may be generated based on associating a randomly generated latent vector to the individual embeddings of the set of embeddings. In some embodiments, the set of embeddings may be generated using a language model (e.g., a large language model, a vision language model, etc.) to compute a respective latent vector for the individual embeddings of the set of embeddings based at least on an input characterizing a corresponding item of the set of items. The item data 114 may correspond, for example, to a catalog of items that is available for a user to select from or otherwise interact with. For example, the item data 114 may comprise a catalog of products available for purchase, a catalog of streaming content available for streaming, media in a library available for loan to a library patron, a catalog of applications available for download, a catalog of instruction manuals and/or help files available for viewing, a catalog of classes available for registration to students, or any other set of discrete items with which a user can interact (e.g., by viewing, browsing, selecting, purchasing, accessing, downloading, and/or streaming). In some embodiments, the set of items is included in training data that further includes session datasets that each may correspond to a distinct session of user interactions with the set of items, and may further capture an ordered sequence in which those user interactions occurred.

Method 500, at B504, includes generating one or more second embeddings based at least on the set of first embeddings, the one or more second embeddings computed based at least on a first portion of an ordered sequence of user interactions with the set of items. As discussed herein, the one or more embeddings may include a session embedding and be computed based at least on a convolution of the first portion generated using the machine learning model (e.g., as described with respect to FIG. 2). In some embodiments, the one or more embeddings may include a session embedding and at least one prior sequence embedding (e.g., as described with respect to FIG. 3). The prior sequence embedding may be computed based at least on a second portion of the ordered sequence, wherein the second portion overlaps in part with the first portion.

Method 500, at B506, includes computing a cosine similarity loss representing a similarity between the one or more second embeddings and a third embedding that represents a next item in the ordered sequence occurring after the first portion. The cosine similarity loss may be computed based at least on a positive cosine similarity component and a negative cosine similarity component. That is, the cosine similarity loss may represent a similarity between the session embedding and a next item GT embedding, and may further represent a dissimilarity between the session embedding and arbitrarily selected items, as represented by the random item embeddings.

For example, the positive cosine similarity component may be computed based at least on a function of a first cosine similarity representing a similarity between the one or more embeddings and the embedding that represents the next item in the ordered sequence. The negative cosine similarity component may be computed based at least on a function of a second cosine similarity representing a similarity between the one or more embeddings and a subset of randomly selected embeddings from the set of embeddings that correspond to a set of random items from the item data. The set of randomly selected embeddings may comprise a relatively large number of embeddings (e.g., ranging from tens of samples to many thousands of samples). The number of random items to include in the set of random items may be determined based on use case considerations. For example, where the set of items includes a population of items that are relatively similar to each other, the number of random items used to compute the negative cosine similarity component may be increased to assist training the recommendation model in distinguishing between those differentiating characteristics that do exist. Similarly, where the set of items includes a relatively limited number of distinct items to use in training, the number of random items used to compute the negative cosine similarity component may be increased to assist training the recommendation model to learn dissimilarities between embeddings for predicted items versus arbitrary items from the set of items. In some embodiments, the set of random items data used to generate the random item embeddings may be refreshed for each training iteration. That is, a new set of random items data may be selected from the set of item data for each new portion of the ordered sequence of user interactions with the set of items.

Method 500, at B508, includes adjusting a machine learning model to compute the one or more second embeddings based at least on the cosine similarity loss. The machine learning model may be iteratively adjusted to maximize the positive cosine similarity component and minimize the negative cosine similarity component. As explained at least with respect to FIG. 4, in some embodiments, an item recommendation may be generated by a trained recommendation model. The item recommendation may be determined based on a session embedding predicted by the trained recommendation model and an item associated with that session embedding determined based on a nearest neighbor search of the set of items available for recommendation. As such, in some embodiments, the method may further include causing a user interface to display an item recommendation from the set of items based at least on performing a nearest neighbor search between at least one embedding of the one or more embeddings and the set of embeddings.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, computing device 410 may be implemented at least in part using computing device 600.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6. In some embodiments, user interactions with item data 114 may be based at least in part on user interactions performed via the presentation component 618. In some embodiments, item recommendation 446 may be displayed to a user via presentation component 618.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, CPU(s) 606, the GPU(s) 608 and/or logic unit(s) 620 may execute code to implement one or more aspects of the recommendation model training system 100 and/or recommendation system 400 described herein. For example, recommendation model 130, item data embedding layer(s) and/or convolution layer(s) 134 may be implemented at least in part as one or more neural networks ececuted on the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, one or more aspects of the recommendation model training system 100 and/or recommendation system 400 described herein are implemented by code executed by one or more of node C.R.s 716(1)-716(N). In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more processing units to:
generate a set of first embeddings, wherein individual embeddings of the set of first embeddings represent individual items of a set of items;
generate one or more second embeddings based at least on the set of first embeddings, the one or more second embeddings computed based at least on a first portion of an ordered sequence of user interactions with the set of items;
compute a cosine similarity loss representing a similarity between the one or more second embeddings and a third embedding that represents a next item in the ordered sequence occurring after the first portion; and
adjust a machine learning model to compute the one or more second embeddings based at least on the cosine similarity loss.

2. The processor of claim 1, wherein the one or more processing units are further to:
generate the set of first embeddings based on associating a randomly generated latent vector to the individual embeddings of the set of first embeddings.

3. The processor of claim 1, wherein the one or more processing units are further to:
generate the set of first embeddings using a large language model to compute a respective latent vector for the individual embeddings of the set of first embeddings based at least on an input characterizing a corresponding item of the set of items.

4. The processor of claim 1, wherein the one or more processing units are further to:
compute the one or more second embeddings based at least on a convolution of the first portion generated using the machine learning model.

5. The processor of claim 1, wherein the one or more processing units are further to:
compute the cosine similarity loss based at least on a positive cosine similarity component and a negative cosine similarity component;
wherein the positive cosine similarity component is computed based at least on a function of a first cosine similarity representing a similarity between the one or more second embeddings and the third embedding that represents the next item in the ordered sequence; and
wherein the negative cosine similarity component is computed based at least on a function of a second cosine similarity representing a similarity between the one or more second embeddings and a subset of randomly selected embeddings from the set of first embeddings.

6. The processor of claim 5, wherein the subset of randomly selected embeddings comprises a plurality of embeddings.

7. The processor of claim 5, wherein the one or more processing units are further to:
select the subset of randomly selected embeddings based at least in part on a size of the set of items.

8. The processor of claim 5, wherein the one or more processing units are further to:
iteratively adjust the machine learning model to maximize the positive cosine similarity component and minimize the negative cosine similarity component.

9. The processor of claim 5, wherein the one or more processing units are further to:
generate the one or more second embeddings further based at least on a second portion of the ordered sequence, wherein the second portion overlaps in part with the first portion.

10. The processor of claim 1, wherein the one or more processing units are further to:
cause a user interface to display an item recommendation from the set of items based at least on performing a nearest neighbor search between at least one embedding of the one or more second embeddings and the set of first embeddings.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system for performing generative AI operations;
a system for generating synthetic data;
a system incorporating one or more virtual machines (VMs);
a system implemented at least partially in a data center; or
a system implemented at least partially using cloud computing resources.

12. A system comprising:
one or more processing units to:
generate, based on a set of first embeddings corresponding to a set of items, one or more second embeddings based at least on a first portion of an ordered sequence of user interactions with the set of items; and
adjust a machine learning model to compute the one or more second embeddings based at least on a cosine similarity loss representing a similarity between the one or more second embeddings and a third embedding that represents a next item in the ordered sequence occurring after the first portion.

13. The system of claim 12, wherein the one or more processing units are further to:
compute the one or more second embeddings based at least on a convolution of the first portion generated using the machine learning model.

14. The system of claim 12, wherein the one or more processing units are further to:
generate the one or more second embeddings based at least on the first portion of an ordered sequence and a second portion of the ordered sequence, wherein the second portion overlaps in part with the first portion.

15. The system of claim 12, wherein the one or more processing units are further to:
use one or more language models to generate a respective latent vector for individual embeddings of the set of first embeddings based at least on an input characterizing a corresponding item of the set of items.

16. The system of claim 15, wherein the one or more language models comprise at least one of: one or more multilingual large language models or one or more vision language models.

17. The system of claim 12, wherein the one or more processing units are further to:
compute a positive cosine similarity component of the cosine similarity loss based at least on a first cosine similarity computed using the one or more second embeddings and the third embedding that represents the next item in the ordered sequence;
compute a negative cosine similarity component of the cosine similarity loss based at least on a second cosine similarity computed using the one or more second embeddings and a set of randomly selected embeddings from the set of first embeddings; and
iteratively adjust the machine learning model to maximize the positive cosine similarity component and minimize the negative cosine similarity component.

18. The system of claim 17, wherein the one or more processing units are further to:
select the set of randomly selected embeddings based at least in part on a size of the set of items.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational artificial intelligence (AI) operations;
a system implementing one or more language models;
a system implementing one or more large language models (LLMs);
a system implementing one or more vision language models (VLMs);
a system for generating synthetic data;
a system for performing generative AI operations;
a system incorporating one or more virtual machines (VMs);
a system implemented at least partially in a data center; or
a system implemented at least partially using cloud computing resources.

20. A method comprising:
updating one or more parameters of a machine learning model to generate a recommendation from a set of items based at least on a cosine similarity loss that represents a similarity between one or more embeddings representing a portion of an ordered sequence of user interactions with the set of items and an embedding that represents a next item in the ordered sequence occurring after the portion.
